(19) United States
(12) Patent Application Publication
(10) Pub. No.: US 2014/0214512 A1
(43) Pub. Date: Jul. 31, 2014

(54) INCENTIVIZING MEDIA STATION USERS

(71) Applicant: APPLE INC., Cupertino, CA (US)

(72) Inventor: William Martin Bachman, San Jose, CA (US)

(73) Assignee: Apple Inc., Cupertino, CA (US)

(21) Appl. No.: 13/871,254

(22) Filed: Apr. 26, 2013

Related U.S. Application Data
(60) Provisional application No. 61/758,211, filed on Jan. 29, 2013.

(51) Int. Cl. G06Q 30/02

(52) U.S. Cl. CPC G06Q 30/0222
USPC 705/14.23

(57) ABSTRACT

Disclosed are systems, methods, and non-transitory computer-readable storage media for incentivizing users to create custom media stations. To incentivize users to create custom media stations, user can be granted rewards for meeting specified rewards conditions. Rewards conditions can be based on the user creating a custom media station as well as the performance of the user's custom media stations. Rewards granted to users as well as the size of the rewards can vary depending on various factors. Rewards can include any variety of possible rewards such as monetary rewards, credits to purchase items, uninterrupted media station play, etc. A countdown timer indicating the remaining amount of uninterrupted media station play can be presented during the uninterrupted media station play. The countdown timer can be replaced with a message indicating that the uninterrupted media play has been exhausted upon the remaining amount of uninterrupted media station play time expiring.

### CROSS REFERENCE TO RELATED APPLICATIONS

This application claims the benefit of U.S. Provisional Patent Application No. 61/758,211, entitled “INCENTIVIZING MEDIA STATION USERS”, filed on Jan. 29, 2013, and which is hereby expressly incorporated herein by reference in its entirety.

### BACKGROUND

1. Technical Field

The present disclosure relates to custom media stations and more specifically to incentivizing users to create custom media stations.

2. Introduction

The internet allows users of online communities to easily share ideas and recommendations with one another. For example, online communities can allow users to recommend songs, movies and television shows to other likeminded users. Although the internet provides this capability, motivating users to share ideas can be a difficult task. For example, user may not want to take the time necessary to write feedback, create playlists, post interests, etc. Accordingly, there is a need for a way to incentivize users to participate in these online communities.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for incentivizing users to create custom media stations. Users can create custom media stations that include media items selected by a user. To incentivize users to create custom media stations, user can be granted rewards for meeting specified rewards conditions.

Rewards conditions can be based on the user creating a custom media station as well as the performance of the user's custom media stations. For example, users can be rewarded for each custom media station they create. Further, users can be rewarded upon their custom media stations being accessed, by a specified number of other users.

In some embodiments, the user can be rewarded based on user interaction with invitational content items presented as part of the user's custom media station.

Rewards granted to users as well as the size of the rewards can vary depending on the various factors. For example, the rewards can vary based on the item purchased by a user, the cost of the purchased item, the user's previous history, such as purchase history, history interacting with invitational content items, etc.

Rewards can include any variety of possible rewards such as monetary rewards, credits to purchase items, etc. Further, in some embodiments, users can be rewarded with an amount of uninterrupted media station play. This can include a media station performed without interruption from invitational content items such as advertisements. In some embodiments, a countdown timer indicating the remaining amount of uninterrupted media station play can be presented during the uninterrupted media station play. The countdown timer can be replaced with a message upon the remaining amount of uninterrupted media station play time expiring. In some embodiments, the message can indicate that the uninterrupted media play has been exhausted. In some embodiments, the message can indicate what the user can do to be granted more uninterrupted user media play time.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment of a computing device;

FIG. 2 illustrates an exemplary system embodiment in which multiple computing devices can be configured to communicate with each other to create and perform a media station on a client device

FIG. 3 illustrates an exemplary method embodiment of granting a reward; and

FIG. 4 illustrates an exemplary method embodiment of granting a user uninterrupted media station play.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

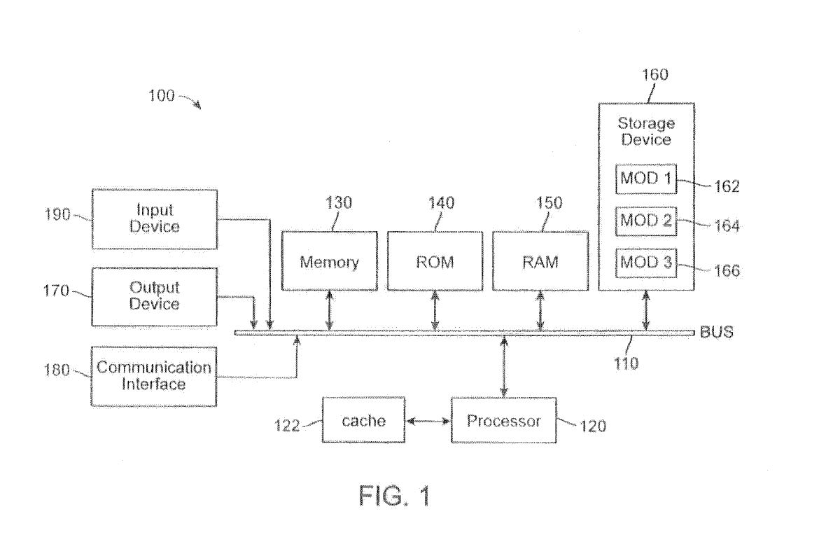

FIG. 1 illustrates an exemplary system 100 that includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

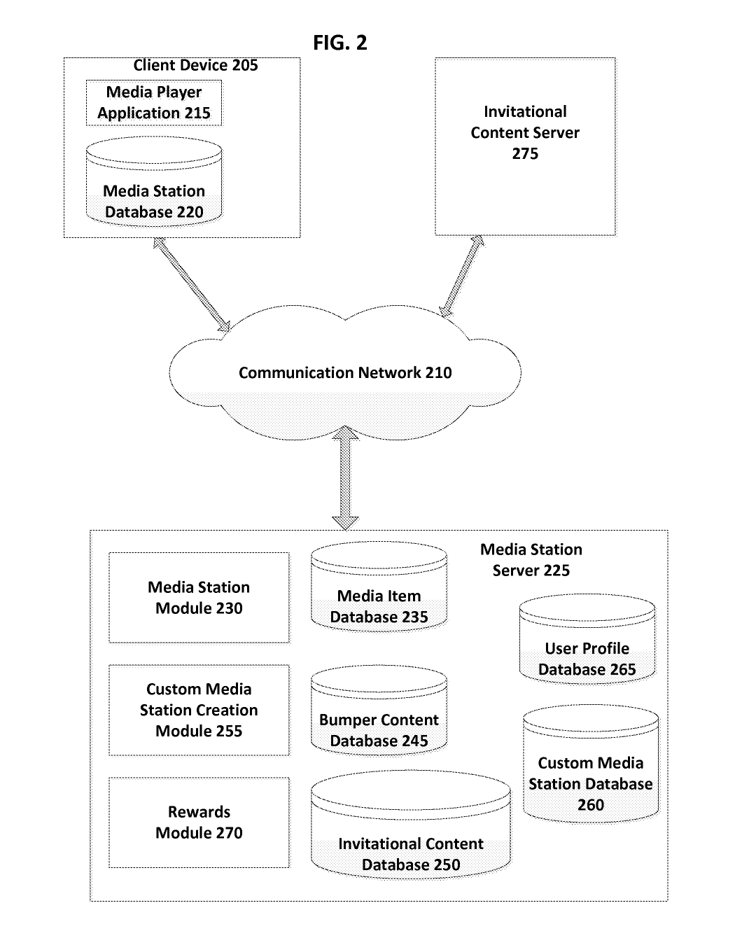

Having disclosed some components of a computing system, the disclosure now turns to FIG. 2, which illustrates an exemplary system embodiment in which multiple computing devices can be configured to communicate with each other to create and perform a media station on a client device. A media station can be a sequence of media items that can be played or executed by a media station player application on a client device. Some non-limiting example of media items can include songs, podcasts, television shows, movies, games, audiobooks, educational courses, and/or video. Other media items are also possible. A media station player can be any application capable of media item playback, such as a component of a webpage, a plug-in, a client-side application, etc.

In some embodiments, a media station can be a continuous sequence of media items such that as one media item completes playback a next media item begins. The playback process of a continuous media item stream can repeat until a user takes an action to terminate or temporarily delay the playback, such as quitting the media player application, switching to a different media station, pausing playback, or skipping a media item. However, a media station can also be defined to be a finite sequence of media items. A media station can be homogeneous or heterogeneous. That is, a media station can be designed to playback media items all of the same media type or of different media types. For example, a homogeneous media station can playback only audio media items or only video media items. In another example, a heterogeneous media station can playback a mix of audio media items and video media items. In some embodiments, the various media items can be presented concurrently such that presentation of one media item overlaps with presentation with a different media item.

A media station can also be configured to play or present invitational content, such as advertisements, within the media stream. An invitational content item can include content found in a media item, such as a song or a video, but an invitational content item can also include targeted content and/or content designed to elicit a response from a user. Therefore an invitational content item and a media item can be distinct item types, each of which can be presented in a media station.

In some embodiments, the invitational content can be used as a source of revenue and/or to subsidize a media station so that the media items can be provided to end users free of charge or for a reduced fee. The invitational content can be presented within a media station using a variety of techniques. In some cases, invitational content can be presented to a user in a manner that prevents or blocks the playback of a next media item or a next segment of a media item. For example, upon the completion of the playback of a music item, but before beginning playback of a new music item, an invitational content item can be presented in the media stream. Invitational content can also be displayed in conjunction with a media item or media item representation. For example, an invitational content item can be presented in a banner ad displayed with a music album cover or during the playback of a television show.

Further, in some embodiments, the invitational content can include an interactive segment that can be presented concurrently with one or more media items. The interactive segment can be configured such that a user can interact with the invitational content without disrupting playback of media items being presented concurrently. A user can thus interact with various features and views of the interactive segment during the playback of a media item without disrupting the media item. For example, in some embodiments, the interactive segment can be a rich media advertisement that includes various views and screens which a user can navigate through while listening to an audio media item.

A downside to presenting both invitational content and media items, either simultaneously or sequentially, when the invitational content is not related to the media items is that a user may equate the media item with the invitational content. For example, a user may think that an invitational content provider endorses a particular media item, or that a media item provider has authorized the use of the media item to promote an offering associated with the invitational content. To decrease the potential for confusion, the media station can also include bumper content, which can be presented concurrently with the interactive invitational content, but just prior to resuming playback of a media item.

A bumper content item can be an intermediary content item that is used to transition from invitational content to a media item, thereby creating user awareness that the media item is not related to an item of invitational content that the user may also be experiencing. For example, a bumper content item can be an audio message such as “now back to the music” that is used to transition between invitational content to an audio media item. Thus a user that is interacting with the interactive segment of an item of invitational content will be made aware that the upcoming media item is not related to the item of invitational content, even though the user is experiencing both concurrently.

To facilitate providing a media station to be performed by a client device, multiple computing devices can be connected to communication network 210 and configured to communicate with each other through use of communication network 210. Communication network 210 can be any type of network, including a local area network (“LAN”), such as an intranet, a wide area network (“WAN”), such as the internet, or any combination thereof. Further, communication network 210 can be a public network, a private network, or a combination thereof. The communication network can also be implemented using any type or types of physical media, including wired communication paths and wireless communication paths associated with one or more service providers. Additionally, communication network 210 can be configured to support the transmission of messages formatted using a variety of protocols.

A computing device can be any type of general computing device capable of network communication with other computing devices. For example, the computing device can be a personal computing device such as a desktop or workstation, a business server, or a portable computing device, such as a laptop, smart phone, or tablet personal computer. The computing device can include some or all of the features, components, and peripherals of computing device 100 of FIG. 1.

To facilitate communication with other computing devices, the computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As illustrated, client device 205 can be configured to communicate with media station server 225 to perform a media station on client device 205. For example, media player application 215 running on client device 205 can be configured to communicate with media station module 230 on media station server 225 to request, receive and perform a media station. Media player application can be any application capable of media item playback, such as a component of a webpage, a plug-in, a client-side application, etc.

Media station module 230 can be configured to create a media station to be performed on client device 205. For example, media station module 230 can be configured to assemble the media station by selecting media items, invitational content items and bumper items to be performed on client device 205 in a specified order. For example, media station server 225 can include media item database 235, bumper content database 245 and invitational content database 250, each configured to store multiple media items, bumper content items, and invitational content items respectively. Media station module 230 can be configured to communicate with databases 235 245 250 to select media items, bumper content items and invitational content to be performed as part of the media station.

Although media item database 235, bumper content database 245 and invitational content database 250 are illustrated separately, this is just one possible embodiment and is not meant to be limiting. In some embodiments, databases 235 245 250 can be combined as one database or any other possible combination.

Alternatively, in some embodiments, databases 235 245 250 can be hosted on separate computing devices and media station module 230 can be configured to communicate with the various computing devices to assemble the media station. For example, in some embodiments, the system can include invitational content server 275 in network communication with media station server 225 and media station module 230 can be configured to communicate with invitational content server 275 to request invitational content to be included in the media station. In some embodiments, invitational content server 275 can transmit the invitational content to media station server 225 where it can be assembled into the media station. In some embodiments, invitational content server 275 can transmit the invitational content directly to client device 205.

In some embodiments, media station module 230 can be configured to transmit the assembled media station to client device 205 where it can be performed by media player application 215. For example, media station module 230 can be in continuous communication with media player application 215 to transmit the media station to be performed by media player application 215.

In some embodiments, media station module 230 can be configured to transmit the media station to client device 205 in segments. For example, media station module 230 can be configured to communicate with client device 205 to transmit an assembled segment of the media station which can be stored on client device 205 and performed by media player application 215. For example, client device 205 can include media station database 220 configured to store the received media station and media player application 215 can be configured to communicate with media station database 220 to retrieve the stored media station. In this type embodiment, media station module 230 can be configured to periodically update client device 205 by transmitting further assembled segments of the media station.

In some embodiments, the media station can be assembled at client device 205 rather than at media station server 225. For example, media station module 230 can be running on client device 205 and can be configured to request media items, bumper content items and invitational content from media station server 225, or any other computing device. The received media items, bumper content items and invitational content can be stored in media station database 220 and media station module 230 can be configured to communicate with media station database 220 to retrieve the stored media items, bumper content items and invitational content to assemble the media station. In this type of embodiment, media station module 230 running on client device 205 can be configured to periodically request further media items, bumper content items and invitational content be delivered to the client device.

Media station module 230 can be configured to assemble the media station based upon media station assembly rules. The media station assembly rules can dictate which media items, invitation content items and bumper content items should be selected for the media station as well as the sequential order in which they should be presented by media player application 215.

In some embodiments, a user can create a custom station that can be shared with other users. For example, media station server 225 can include custom media station creation module 255 configured to enable a user to create a custom media station. Creating a custom media station can include selecting or influencing the media items to be presented as part of the media station. For example, in some embodiments, creating a custom media station can include selecting each media item to be performed as part of the media station. In some embodiments, creating a custom media station can include selecting a genre from which media items should be selected to be performed as part of the media station. In some embodiments, creating a custom media station can include selecting artists from which the media items should be selected. For example, a user can select that the media station only play songs by artists Slayer and Carly Rae Jepsen.

In addition to selecting the media items to be included, creating a custom media station can also include selecting the order in which media items are performed. For example, a user can select the exact order in which the selected media items should be performed as part of the custom media station. In some embodiments, a user can provide rules dictating the order in which the media items are performed. For example, a user can dictate that a Carly Rae Jepsen song always be played after a Slayer song, or that the media station alternate between songs by the two artists.

To enable a user to create a custom media station, custom media station creation module 255 can be configured to provide a custom media station creation interface on client device 205. A custom media station creation interface can be an interface enabling a user to enter preferences for creating a custom media station. For example, the custom media station creation interface can be configured to enable a user to select media items, artists, genres, etc. to include in a custom media station. Further, custom media station creation module 255 can be configured to enable a user to select preferences such as an order in which media items are to be performed as part of the media station.

Media station creation module 255 can further enable a user to save created custom media stations and share the created custom media stations with other users. For example, in some embodiments, media station server 225 can include custom media station database 260 configured to store the created custom media stations. Custom media station creation module 255 can be configured to communicate with custom media station database 260 to store created custom media stations.

To share created custom media stations, in some embodiments, media station server 225 can be configured to transmit metadata describing the stored custom media stations to client device 205. Media playing application 215 can be configured to use the received metadata to present available custom media stations to a user. Further, media playing application 215 can be configured to enable a user to select a custom media station to be presented on client device 205.

Custom media stations can include media items selected by a user or whose selection is influenced by the user. However, invitational content presented along with the media items can alternatively be selected by media station module 230. For example, media station module 230 can select invitational content items and bumper content items from invitational content database 250 and bumper creation database 245, respectively, to be included in the custom media station. In some embodiments, a combination of methods can be utilized to select the media items for the custom media station.

In some embodiments, media station server 225 can be configured to incentivize users to create custom media stations. For example, media station server 225 can be configured to grant rewards to users for creating custom media stations.

To accomplish this, media station server 225 can include user profile database 265 and reward module 270. User profile database 265 can be configured to store a user profile for each user of media station server 225. A user profile can include a variety of data regarding a user such as the user's name, address, username, password, likes, dislikes, favorite media stations, user devices, previous media station usage, etc.

Further, a user profile can include data regarding custom media stations created by the user. For example, a user profile can include a record of each custom media station created by the user. In some embodiments, a user profile can further include usage data regarding the custom media stations created by the user. This can include the number of times the custom media station has been presented, the number of unique users that have accessed the custom media station, feedback received from various users regarding the custom media station, etc.

Alternatively, in some embodiments, usage data regarding a custom media station can be stored in custom media station database 260. In this type of embodiments, a user's user profile can include data identifying the custom media stations created by the user. The data identifying the custom media stations created by the user can be used to access the usage data regarding the custom media station from custom media station database 260.

Reward module 270 can be configured to manage granting rewards to users based on a set of rewarding rules that dictate rewards conditions by which a user is to be granted a reward. The rewarding rules can further dictate the specific reward to be granted as well as the size of the reward. To accomplish this, reward module 270 can be configured to communicate with user profile database 265 and custom media station database 260 to monitor the various user profiles and the performance data regarding the custom media stations created by the users to determine whether any rewards conditions dictated by the rewarding rules have been met. Upon a determination that a rewards condition has been met, reward module 270 can be configured to grant the appropriate user the reward for satisfying the rewards condition, as dictated by the rewarding rules. Further, in some embodiments, reward module 270 can be configured to record rewards granted to a user in the user profile associated with the user.

The rewarding rules can dictate any variety of rewards conditions. In some embodiments, the rewards conditions can be based on the number of custom media stations created by a user. For example, the rewarding rules can dictate that a user be granted a reward each time the user creates a custom media station. Alternatively, the rewarding rules can dictate that a user be granted a reward for every four custom media stations created by the user.

In some embodiments, the rewards conditions can be based on the performance or popularity of the custom media stations created by the user. For example, the rewarding rules can dictate that a user be granted a reward upon a user's custom media station having been presented a predetermined number of times or for a predetermined amount of time. For example, the rewarding rules can dictate that a user be granted a reward upon the user's custom media station having been performed for ten hours, or accessed ten times.

In some embodiments, the rewarding rules can dictate that a user be granted a reward based on the number of unique users that access the user's custom media station. For example, the rewarding rules can dictate that the user be granted a reward upon ten different users accessing the user's custom media station.

In some embodiments, the rewarding rules can dictate that a user be granted a reward based on feedback received from other users regarding the user's custom media stations. For example, the rewarding rules can dictate that the user be granted a reward upon the user's custom media station receiving ten positive reviews or likes. In some embodiments, the rewarding rules can dictate that the user be granted a reward upon the user's custom media station receives a predetermined number of follows.

In some embodiments, the rewarding rules can dictate that the rewarding conditions have to be met by a single custom media station for the user to be granted a reward. In some embodiments, the rewarding rules can dictate that the rewarding conditions can be met by the sum of the various custom media stations created by a user. Thus a rewards condition that the user's custom media stations receive ten positive reviews can be met upon two of the user's custom media stations each receiving five positive reviews.

In some embodiments, the rewarding rules can be based on user interaction with invitational content items presented along with the user's custom media stations. For example, the rewarding rules can dictate that a reward be granted upon users selecting and viewing ten invitational content items presented as part of the user's custom media station. Alternatively, the rewarding rules can dictate that the user be granted a reward upon users purchasing ten items advertised by invitational content items presented as part of the user's custom media station.

In some embodiments, rewards can be granted to incentivize behavior other than creating custom media stations. For example, in some embodiments, media station server 225 can be configured to grant rewards to incentivize user to make purchases. For example, the rewarding rules can dictate that a reward be granted based upon purchases made by a user. Purchases made by a user can be recorded in the user's user profile in user profile database 265. The purchases can be for any of a variety of items. For example, in some embodiments, the purchase can be for a media item presented as part of the media station.

Upon a determination that a user has met a rewards condition, reward module 270 can be configured to grant the user with the reward associated with the rewards condition as dictated by the rewarding rules.

Any of a variety of rewards can be granted to a user as an incentive to create custom media stations. For example, in some embodiments, a user can be granted with an amount of uninterrupted media station play. Uninterrupted media station play can be the media station presented without interruption from invitational content items and/or bumper content items. Thus, a user can be rewarded with thirty minutes of media station play that is uninterrupted by invitational content items such as advertisements.

In some embodiments, a reward can be a monetary reward such as money or credit to purchase items. In some embodiments, a reward can be a tangible item, such as a t-shirt, CD, DVD, book, etc. In some embodiments, a reward can be a digital item such as a media item that can be downloaded by a user. Thus, a user can be granted a reward such as a digital version of a song, video, book, etc.

In some embodiments, a reward can be unlocking a media item to be performed as part of a media station. For example, a reward can be unlocking an unreleased version of a song or a song associated with a higher royalty cost.

In some embodiments, a reward can be unlocking one of a sequence of media items that are related. For example, a user can be rewarded one song from an album or live performance. In this type of embodiment, the user can be rewarded a new song from the album each time the user earns a new reward. Alternatively, the user can be rewarded a portion of a video series such that each time the user earns a reward they are granted access to view the next sequential portion of the video series.

In some embodiments, the rewarding rules can dictate further limitations or conditions for granting rewards. For example, the rewarding rules can dictate limits on the rewards a user can receive. Thus, in some embodiments, the rewarding rules can dictate that a user cannot be granted more than one hour of uninterrupted media station play per day.

Further, in some embodiments, the rewarding rules can dictate the size of the reward granted to the user. For example, the size of the reward can be based on the previous history of the user, such as the user's previous purchase history, previous history interacting with items of invitational content, previous history interacting with media stations, etc. The rewarding rules can dictate that a larger reward be granted when a user has a longer history of performing certain actions. For example, the rewarding rules can dictate that a user be granted a larger amount of uninterrupted media station play when the user has purchased above a certain number of items. Alternatively, the rewarding rules can dictate that a user be granted a larger amount of uninterrupted media station play when the user has interacted with over a specified amount of invitational content items.

In some embodiments, the rewarding rules can dictate the size of a reward based on an item purchased by the user. For example, the purchase of some items can result in a greater reward than the purchase of other items. For example, the purchase of an album can be rewarded with a larger reward than the purchase of a single song. In some embodiments, the size of the reward can be based on the purchase price of the item. Thus, the greater the purchase price, the larger the reward rewarded to the user.

In some embodiments, the rewarding rules can be based on demographic data gathered regarding the user that created the custom media station and/or demographic data regarding the users that access a custom media station. For example, the rewarding rules can dictate that a reward be granted upon a predetermined number of users that are part of a specified demographic group accessing the custom media station. Thus the rewarding rules can dictate that a user be granted award upon ten males in their twenties accessing the user's custom media station.

In some embodiments, the size of the reward or the reward itself can vary depending on demographic data regarding the users that access the custom media station. For example, a user can be grated a larger reward if the users that access the custom media station are part of specified demographic group. For example, a user can be granted a larger reward, such as a greater amount of uninterrupted media station play, when the users that access the media station are part of a demographic group that historically does not access media stations. Alternatively, the user can be granted a larger reward when user's that historically do not interact with invitational content, interact with invitational content included as part of the user's custom media station. In this way, the rewards can be used to incentivize users to create custom media stations that attract users that generally do not access media stations.

In some embodiments, the reward granted to a user can vary depending on demographic data of the user that creates the custom media station. For example, the rewarding rules can dictate that different awards can be granted based on the demographic group to which the user that created the custom media station belongs. For example, the rewarding rules can dictate that a user that is a male and in his teens be granted a song by Slayer, while a user that is a female in her teens be granted a song by Carly Rae Jepsen.

In some embodiments, the rewarding rules can take into account geolocation data. For example, the reward granted as well as the size of the reward granted can vary based on geolocation data of the user that created the custom media station or the users that access or interact with the custom media station. Thus, in some embodiments, the rewarding rules can dictate that the reward granted to a user that lives in California is different than the reward granted to a user that lives in New York. In some embodiments, the rewarding rules can be based on actions of the user that created the custom media station. For example, the user can be rewarded for sharing the media station with friends. Sharing a media station can include sending a message to friend alerting the friend of the custom media station. For example, the user can e-mail or text the message to a friend. In some embodiments, the message can include a link that can directly connect the friend to the custom media station. In some embodiments, sharing the custom media station can include posting a link to the custom media station on a social networking site. The rewarding rules can dictate that a user receive a reward upon sharing a custom media station a predetermined number of times or with a predetermined number of friends.

In some embodiments, the rewarding rules can be based on the response received to a shared custom media station. For example, the rules can dictate that the user be rewarded based on the number of users that re-share the custom media station. In some embodiments, the user can be rewarded based on a measured virality of a shared custom media station. Virality can be measured in any of a variety of ways known in the art. For example, virality can be calculated based on factors such as the number of users that the user shared the custom media station with, the number of re-shares that resulted from the user sharing the custom media station, etc.

It should be noted, that the above example are just a few possible embodiments and are not meant to be limiting. One skilled in the art would recognize that rewarding rules can be based on any number of factors and this disclosure contemplates any and all such variations.

To grant a reward, in some embodiments, reward module 270 can be configured to present a user with a reward code that can be used to redeem the reward. For example, the reward code can be used to redeem a song or credit at an online store. In some embodiments, the reward code can be e-mailed to the user. In some embodiments, the reward code can be presented to the user as part of the media station.

In some embodiments, reward module 270 can be configured to grant a reward by updating a user's user profile to indicate that the reward has been granted to the user. For example, reward module 270 can update the user's user profile to indicate that the user has been granted access to a previously locked media item. Media station module 230 can be configured to communicate with user profile database 265 to access this data when selecting media items to be include in a media station presented to the user. Thus, media station module 230 can determine which unlocked media items the user has been granted as a reward, and include those media items when selecting media items to be presented as part of a media station presented to the user.

Similarly, rewards module 270 can update a user's user profile to indicate an amount of uninterrupted media station play that has been granted to the user as a reward. Media station module 230 can access this data and present the media station to the user without invitational content items for the indicated time. Further, media station module 230 can be configured to update this data in the user's user profile as the user uses the granted uninterrupted media station play.

Alternatively, in some embodiments, reward module 270 can be configured to send a command to media station module 230 that a reward has been granted to the user. For example, rewards module 270 can send a command to media station module 230 to present an unlocked media item to the user. Media station module 230 can present the unlocked media item in response to receiving the command. In some embodiments, media station module 230 can present the user with a user interface element, such as a button, that enables the user to select that the unlocked media item be presented.

Rewards module 270 can also be configured to send a command to media station module 230 to present the media station uninterrupted by invitational content items. Rewards module 270 can further be configured to monitor the remaining amount of uninterrupted media station play and send a command to media station module 230 to resume media station playback with invitational content when the user has exhausted the granted amount of uninterrupted media station play.

In some embodiments, reward module 270 can be configured to present an indication that a user is receiving uninterrupted media station play as a reward. For example, reward module 270 can be configured to present a message within the media station that indicates that the user is receiving uninterrupted media play.

In some embodiments, reward module 270 can further be configured to present an indication of the remaining amount of uninterrupted media station play remaining. For example, the user can be presented with a timer counting down the remaining amount of uninterrupted commercial free media station play.

In some embodiments, reward module 270 can be configured to present a message along with the indication of the remaining amount of uninterrupted media station play remaining. For example, the message can indicate that the user's uninterrupted media station play time is ending shortly. In some embodiments, the message can include instructions on how to be granted more uninterrupted media station play time. For example, the message can state “purchase another song to receive 10 more minutes of commercial free radio!” Alternatively, in some embodiments, the message can notify the user about how close the user is to receiving another reward. For example, the message can state “You will receive another 10 minutes of commercial free radio when 5 more users listen to your custom station!” This type of message can spur the user to edit the created custom media station or share it with more users.

In some embodiments, reward module 270 can be configured to present a message upon the user has exhausted the granted amount of uninterrupted media station play. For example, in some embodiments, reward module 270 can replace the countdown timer indicating the remaining amount of uninterrupted media station play with a message that the amount of uninterrupted media station play has been exhausted.

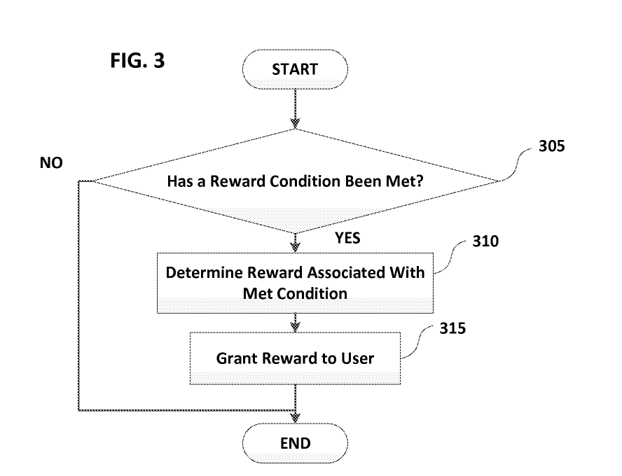

FIG. 3 illustrates an exemplary method embodiment of granting a reward. As illustrated, the method begins at block 305 where it is determined whether a reward condition has been met. The determination can be based on data gathered regarding a user such as the user's purchase history, custom media stations created by the user, the user's previous interactions with invitational content items, etc. Further, data regarding the performance of the user's custom media stations can also be gathered. The gathered data can be used to determine whether a reward condition has been met. The rewards conditions can be dictated by a set of rewarding rules.

Upon a determination that a reward condition has been met, the method continues to block 310 where the reward associated with the met reward condition is identified. For example, the rewarding rules can dictate the reward to be granted for meeting the reward condition.

The method then continues to block 315 where the identified reward is granted to the user. For example, in some embodiments, a user profile associated with a user can be updated to indicate that the user has been granted the reward. In some embodiments, a code to redeem the reward can be transmitted to the user. In some embodiments, uninterrupted media station play can be granted to the user.

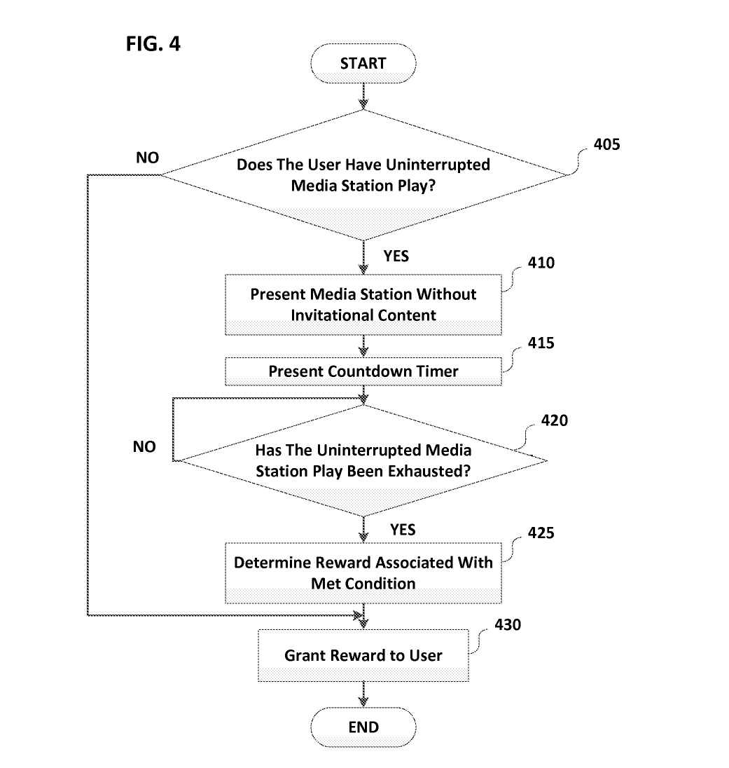

FIG. 4 illustrates an exemplary method embodiment of granting a user uninterrupted media station play. The method begins at block 405 where it is determined whether the user has any remaining uninterrupted media station play. For example, the user may have been granted the uninterrupted media station play as a reward for meeting a reward condition as described in the method illustrated in FIG. 3.

To determine whether the user has any remaining uninterrupted media station play, in some embodiments, a user profile associated with the user can be checked. The user profile can include profile data regarding the user, such as the amount of any remaining uninterrupted media station play.

If at block 405 it is determined that the user does not have any remaining uninterrupted media station play time, the method continues to block 430 where the user is presented with the media station including invitational content.

If at block 405 it is determined that the user does have remaining uninterrupted media station play time the method continues to block 410 where the media station is presented to the user without interruption from invitational content items.

The method continues to block 415 where the user is presented with a countdown timer indicating the remaining amount of uninterrupted media station play time allotted to the user. Although block 415 is presented after block 410, the two can occur simultaneously.

The method then continues to block 420 where it is determined whether the user's uninterrupted media station time has been exhausted. If it is determined that the user's uninterrupted media station time has been exhausted, the method continues to block 425 where the countdown timer is replaced with a message indication the user has exhausted their uninterrupted media station play time.

The method then continues to block 430 where the user is presented with the media station that includes invitational content items. Although block 430 is presented as occurring after block 425, the two blocks can occur simultaneously.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
upon processing a purchase request associated with a user account, granting the user account a reward of an amount of uninterrupted media station play, wherein the purchase request is for an item other than uninterrupted media station play; and
displaying an indication of a remaining amount of uninterrupted media station play while the uninterrupted media station play is presented to a client device associated with the user account.

2. The method of claim 1, wherein a media station is streaming radio.

3. The method of claim 1, wherein the purchase request is for a media item.

4. The method of claim 1, wherein the indication of the remaining amount of uninterrupted media station play is a countdown timer.

5. The method of claim 1, further comprising:
upon the amount of uninterrupted media station play being exhausted, replacing the indication of the remaining amount of uninterrupted media station play with a message indicating that the amount of uninterrupted media station play has completed.

6. The method of claim 1, wherein the amount of commercial free media services granted to the user account is dependent on the purchase request associated with the user account.

7. The method of claim 6, wherein the amount of uninterrupted media station play granted to the user account dependent on a purchase price associated with the purchase request.

8. The method of claim 6, wherein the amount of uninterrupted media station play granted to the user account is dependent on a purchased item associated with the purchase request.

9. The method of claim 1, wherein the amount of uninterrupted media station play granted to the user is dependent on a purchase history associated with the user account.

10. The method of claim 9, wherein the amount of uninterrupted media station play granted to the user when the purchase history indicates a previous purchase associated with the user account is greater than when the purchase history indicates that there are no previous purchases associated with the user account.

11. A system comprising:
a processor; and
a memory containing instruction that, when executed, cause the processor to:
upon processing a purchase request associated with a user account, grant the user account a reward of an amount of uninterrupted media station play, wherein the purchase request is for an item other than uninterrupted media station play; and
display an indication of a remaining amount of uninterrupted media station play while the uninterrupted media station play is presented to a client device associated with the user account.

12. The system of claim 11, wherein a media station is streaming video.

13. The system of claim 11, wherein the purchase request is for a physical item.

14. The system of claim 11, wherein the indication of the remaining amount of uninterrupted media station play is a countdown timer.

15. The system of claim 11, wherein the instructions further cause the processor to:
upon the amount of uninterrupted media station play being exhausted, replace the indication of the remaining amount of uninterrupted media station play with a message indicating that the amount of uninterrupted media station play has completed.

16. The system of claim 11, wherein the amount of commercial free media services granted to the user account is dependent on the purchase request associated with the user account.

17. The system of claim 16, wherein the amount of uninterrupted media station play granted to the user account dependent on a purchase price associated with the purchase request.

18. The system of claim 16, wherein the amount of uninterrupted media station play granted to the user account is dependent on a purchased item associated with the purchase request.

19. The system of claim 11, wherein the amount of uninterrupted media station play granted to the user is dependent on a purchase history associated with the user account.

20. The system of claim 19, wherein the amount of uninterrupted media station play granted to the user when the purchase history indicates a previous purchase associated with the user account is greater than when the purchase history indicates that there are no previous purchases associated with the user account.

21. A non-transitory computer-readable medium containing instructions that, when executed by a computing device, cause the computing device to:
upon processing a purchase request associated with a user account, grant the user account a reward of an amount of uninterrupted media station play, wherein the purchase request is for an item other than uninterrupted media station play; and
display an indication of a remaining amount of uninterrupted media station play while the uninterrupted media station play is presented to a client device associated with the user account.

22. The non-transitory computer-readable medium of claim 21, wherein a media station is a Podcast.

23. The non-transitory computer-readable medium of claim 21, wherein the purchase request is for a media item.

24. The non-transitory computer-readable medium of claim 21, wherein the indication of the remaining amount of uninterrupted media station play is a countdown timer.

25. The non-transitory computer-readable medium of claim 21, wherein the instructions further cause the computing device to:
upon the amount of uninterrupted media station play being exhausted, replace the indication of the remaining amount of uninterrupted media station play with a message indicating that the amount of uninterrupted media station play has completed.

26. The non-transitory computer-readable medium of claim 21, wherein the amount of commercial free media services granted to the user account is dependent on the purchase request associated with the user account.

27. The non-transitory computer-readable medium of claim 26, wherein the amount of uninterrupted media station play granted to the user account dependent on a purchase price associated with the purchase request.

28. The non-transitory computer-readable medium of claim 26, wherein the amount of uninterrupted media station play granted to the user account is dependent on a purchased item associated with the purchase request.

29. The non-transitory computer-readable medium of claim 21, wherein the amount of uninterrupted media station play granted to the user is dependent on a purchase history associated with the user account.

30. The non-transitory computer-readable medium of claim 29, wherein the amount of uninterrupted media station play granted to the user when the purchase history indicates a previous purchase associated with the user account is greater than when the purchase history indicates that there are no previous purchases associated with the user account.
